(19) United States
(12) Patent Application Publication
(10) Pub. No.: US 2025/0299093 A1
(43) Pub. Date: Sep. 25, 2025

(54) PROGRAMMING LANGUAGE AS A DATA STRUCTURE

(71) Applicant: International Business Machines Corporation, Armonk, NY (US)

(72) Inventors: Nathaniel H. Park, San Jose, CA (US); James L. Hedrick, Pleasanton, CA (US); Sarathkrishna Swaminathan, Santa Clara, CA (US); Tim Erdmann, San Jose, CA (US)

(21) Appl. No.: 18/614,981

(22) Filed: Mar. 25, 2024

(51) Int. Cl. G06N 20/00

(52) U.S. Cl. CPC G06N 20/00

(57) ABSTRACT

Embodiments of the invention provide a computer-implemented method that includes executing a machine learning (ML) model operable to perform a ML task that includes generating a ML output responsive to a ML input. The ML output includes encoded domain information associated with a domain. The encoded domain information is encoded in a computer-code-based domain-specific data structure, and the ML task is associated with the domain.

### BACKGROUND

The present invention relates in general to programmable computers that implement neural networks. More specifically, the present invention related to computer-implemented methods, computer systems, and/or computer program products operable to utilize novel programming-language-based data structures to develop and implement various types of machine learning models, including specifically generative machine learning models. In some embodiments, the novel programming-language-based data structure is a domain-specific programming-language-based data structure.

Electronic information can be categorized as unstructured, semi-structured, or structured. Unstructured electronic information is not organized in a uniform format (i.e., it is not labeled or otherwise organized) and can include text, images, video, and audio material. Similarly, semi-structured electronic information includes some form of organization (e.g., some semantic labels/tags) but the chosen organization method lacks consistency, is not standardized, or has some other deficiency. In contrast, structured electronic information is information that has been well-organized and arranged in a systematic, easily accessible way, including, for example, attaching consistent labels to the electronic information and/or organizing the electronic information into an addressable repository or a database.

### SUMMARY

Embodiments of the invention provide a computer-implemented method that includes executing a machine learning (ML) model operable to perform a ML task that includes generating a ML output responsive to a ML input. The ML output includes encoded domain information associated with a domain. The encoded domain information is encoded in a computer-code-based domain-specific data structure, and the ML task is associated with the domain.

Embodiments of the invention further provide a computer-implemented method that includes executing a ML model operable to perform a ML task that includes generating a ML output responsive to a ML input. The ML output includes encoded domain information associated with a domain. The encoded domain information is encoded in a domain-specific programming language data structure. The ML model is operable to understand a domain-specific syntax of the domain-specific programming language data structure, and the ML task is associated with the domain.

Embodiments of the invention further provide a computer-implemented method that includes accessing encoded domain information encoded in a domain-specific programming language data structure. The encoded domain information results from an encoding operation that generates, based at least in part on domain information having multiple data structures, the encoded domain information encoded in the domain-specific programming language data structure. The method further includes using the encoded domain information to generate a ML model operable to perform a ML task that includes generating a ML output responsive to a ML input. The ML model is operable to understand a domain-specific syntax of the domain-specific programming language data structure, and the ML task is associated with the domain.

Embodiments of the invention are also directed to computer systems and computer program products having substantially the same features and functionality as the computer-implemented methods described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2A depicts a simplified block diagram illustrating a model of a biological neuron operable to be utilized in neural network (NN) architectures in accordance with aspects of the invention;

FIG. 2B depicts a simplified block diagram illustrating a deep learning NN architecture in accordance with aspects of the invention;

FIG. 3 depicts a diagram illustrating a non-limiting example of a dimensionality reduction operation operable to utilize word embeddings in accordance with embodiments of the invention;

FIG. 4A depicts a simplified block diagram illustrating a non-limiting example of a transformer NN architecture operable to implement aspects of the invention;

FIG. 4B depicts a simplified block diagram illustrating a non-limiting example of an encoder element of a transformer NN architecture operable to implement aspects of the invention;

FIG. 4C depicts a simplified block diagram illustrating a non-limiting example of a decoder element of a transformer NN architecture operable to implement aspects of the invention;

FIG. 5A depicts a string representation of a molecular structures that can be encoded using aspects of the invention;

FIG. 5B is a non-limiting example of a natural language (NL) text description of a chemical-based or materials-based experimental protocol that can be encoded using aspects of the invention;

FIG. 6 depicts a table summarizing a known use of a machine learning model to generate computer code;

FIG. 7 depicts a table summarizing a non-limiting example of how a domain-specific computer programming language can be used, in accordance with embodiments of the invention, as a programming-language-based encoding technique operable to encode data/information that is used to train/generate a machine learning model;

FIG. 8A depicts a simplified block diagram illustrating a non-limiting example of a novel computer-based encoding system operable to generate encoded domain-specific information in accordance with aspects of the invention;

FIG. 8B depicts a simplified block diagram illustrating additional details of the encoded domain-specific information depicted in FIG. 8A;

FIG. 9A depicts a simplified block diagram illustrating a neural network architecture during a training or generation process that teaches the neural network the encoded domain-specific information and associated tasks in accordance with aspects of the invention;

FIG. 9B depicts a simplified block diagram illustrating a neural network architecture, post model training/generation, operable to perform tasks using encoded domain-specific information in accordance with aspects of the invention;

FIG. 9C depicts a simplified block diagram illustrating a large language model (LLM) implementation of a neural network architecture, post model training/generation, operable to perform tasks using encoded domain-specific information in accordance with aspects of the invention;

FIG. 10 depicts a simplified block diagram illustrating a neural network architecture during a training or generation process that teaches the neural network to read and understand real instances and synthetic instances of the encoded domain-specific information, and further teaches the neural network to perform associated tasks, all in accordance with aspects of the invention;

FIG. 11 depicts a non-limiting example of input queries and associated outputs generated by a neural network architecture operable to perform tasks using encoded domain-specific information in accordance with aspects of the invention;

FIG. 12 depicts a non-limiting example of input queries and associated outputs generated by a neural network architecture operable to perform tasks using encoded domain-specific information in accordance with aspects of the invention;

FIG. 13 depicts a non-limiting example of an input query and an associated output generated by a neural network architecture operable to perform tasks using encoded domain-specific information in accordance with aspects of the invention;

FIG. 14 depicts a type of generative network that can be used to implement aspects of the invention; and

FIG. 15 depicts another type of generative network that can be used to implement aspects of the invention.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

Embodiments of the invention provide a computer-implemented method that includes executing a machine learning (ML) model operable to perform a ML task that includes generating a ML output responsive to a ML input. The ML output includes encoded domain information associated with a domain. The encoded domain information is encoded in a computer-code-based domain-specific data structure, and the ML task is associated with the domain.

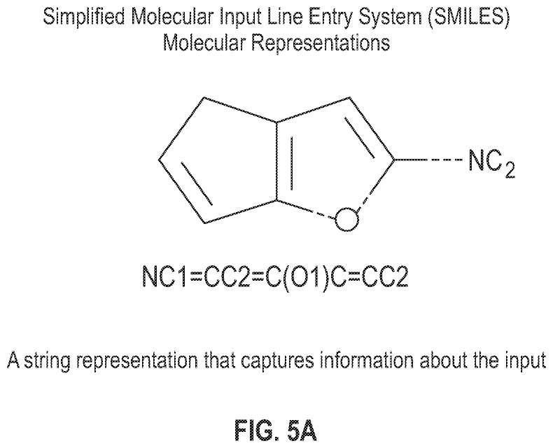

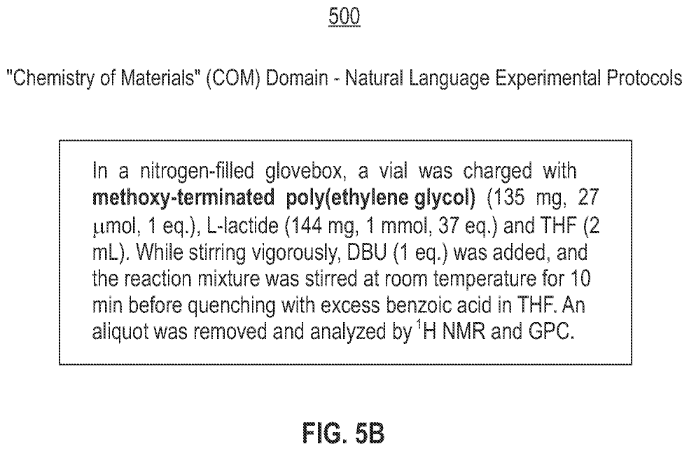

The above-described embodiments of the invention provide technical benefits and technical effects. For example, the novel computer-code-based domain-specific data structures are operable to represent various aspects of data/information and associated domains, including, for example, domain-specific data/information and/or associated domain-specific data/information analysis techniques. The data/information encoding format can be configured and arranged to take on the representation-based attributes of a computer programming language. In general, a computer programming language is a specialized “language” configured and arranged to express a set of detailed instructions for a digital computer. Contrary to conventional uses of computer code, the computer code is not used in embodiments of the invention to instruct the computer to perform an action, per se. Instead, the computer code and is used in embodiments of the invention to represent in a computer-code format the various aspects of data/information and associated data/information analysis techniques, including specifically domain-specific data/information and/or associated domain-specific data/information analysis techniques. Non-limiting examples of the domain-specific data/information and/or the domain-specific data/information analysis techniques that can be encoded as computer code in a computer programming language and analyzed using embodiments of the invention include the example SMILES string shown in FIG. 5A, as well as the NL COM domain experimental protocol 500 shown in FIG. 5B.

In addition to any one or more of the features described herein, the ML input comprises pre-encoded domain information, and, in some embodiments of the invention, the pre-encoded domain information comprises a natural language question comprising a natural language data structure. In some embodiments of the invention, the ML output is responsive to the natural language question of the ML input.

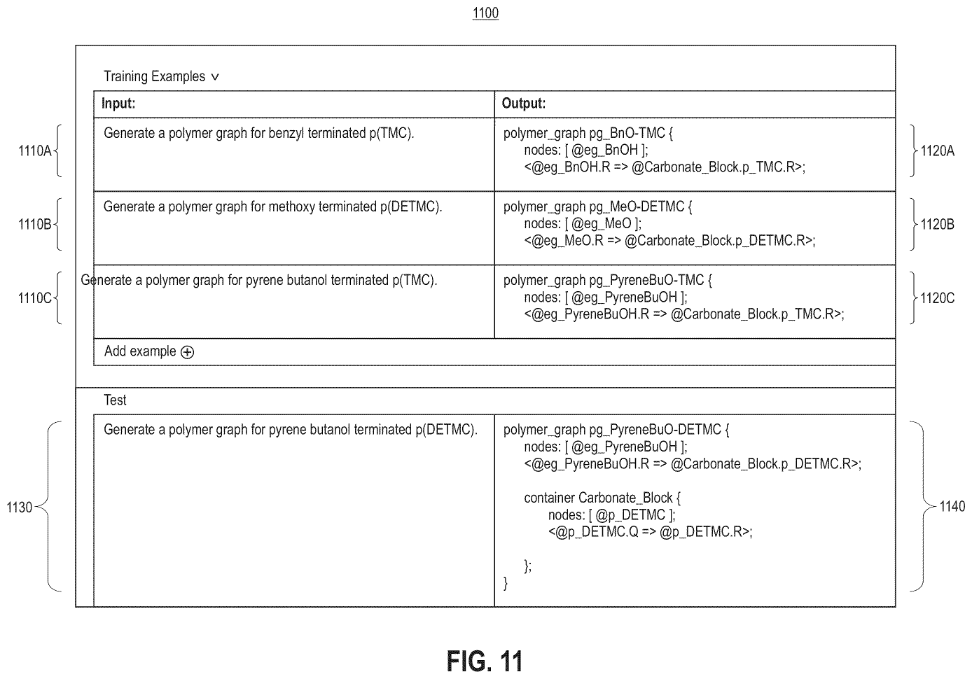

The above-described embodiments of the invention provide technical benefits and technical effects. For example, the ML model in embodiments of the invention can be used to implement a type of document/data content analysis (DCA) system, which is referred to herein as a “question and answer (QA) system” that use NLP and machine learning algorithms to provide answers to open-ended NL questions. Thus, the ML input can be a NL question, and the ML output can be data/information that is responsive to the NL question in the ML input, where the data information in the ML output that is responsive to the NL question in the ML input is encoded in the computer-code-based domain-specific data structure. Non-limiting examples of the ML inputs as NL questions (e.g., 1110A, 1110B, 1110C, 1130) are show in FIG. 11, and non-limiting examples of the ML outputs (1120A, 1120B, 1120C, 1140) as answers to the ML inputs in the form of encoded domain information encoded in a computer-code-based domain-specific data structure are shown in FIG. 11.

In addition to any one or more of the features described herein, the ML model comprises a large language model (LLM) operable to understand a domain-specific syntax of the computer-code-based domain-specific data structure.

The above-described embodiments of the invention provide technical benefits and technical effects. For example, the novel computer-code-based domain-specific data structures are operable to represent various aspects of data/information and associated domains, including, for example, domain-specific data/information and/or associated domain-specific data/information analysis techniques. The data/information encoding format can be configured and arranged to take on the representation-based attributes of a computer programming language. In general, a computer programming language is a specialized “language” configured and arranged to express a set of detailed instructions for a digital computer. Contrary to conventional uses of computer code, the computer code and associated syntax are not used in embodiments of the invention to instruct the computer to perform an action, per se. Instead, the computer code and associated syntax are used in embodiments of the invention to represent in a computer-code format the various aspects of data/information and associated data/information analysis techniques, including specifically domain-specific data/information and/or associated domain-specific data/information analysis techniques. Non-limiting examples of the domain-specific data/information and/or the domain-specific data/information analysis techniques that can be encoded as computer code in a computer programming language and analyzed using embodiments of the invention include the example SMILES string shown in FIG. 5A, as well as the NL COM-related experimental protocol 500 shown in FIG. 5B.

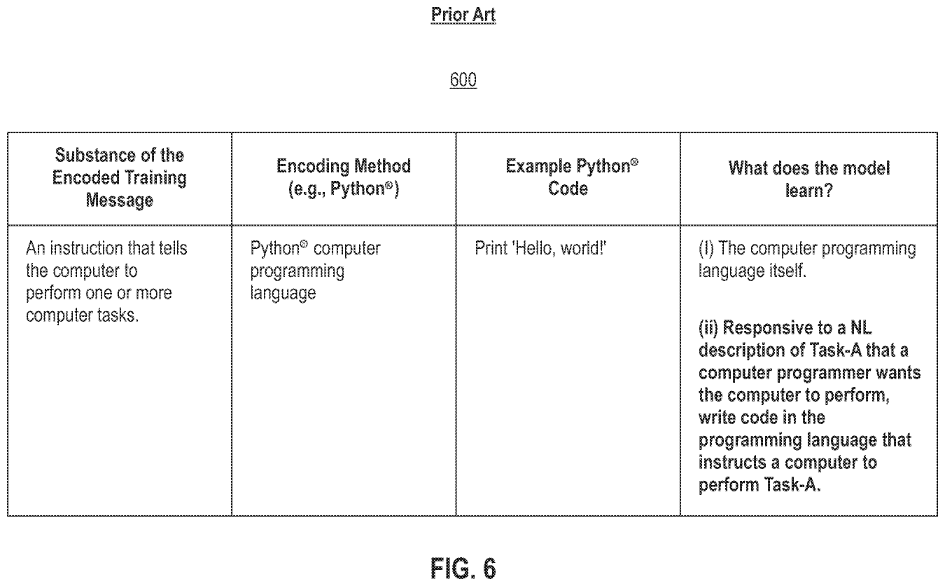

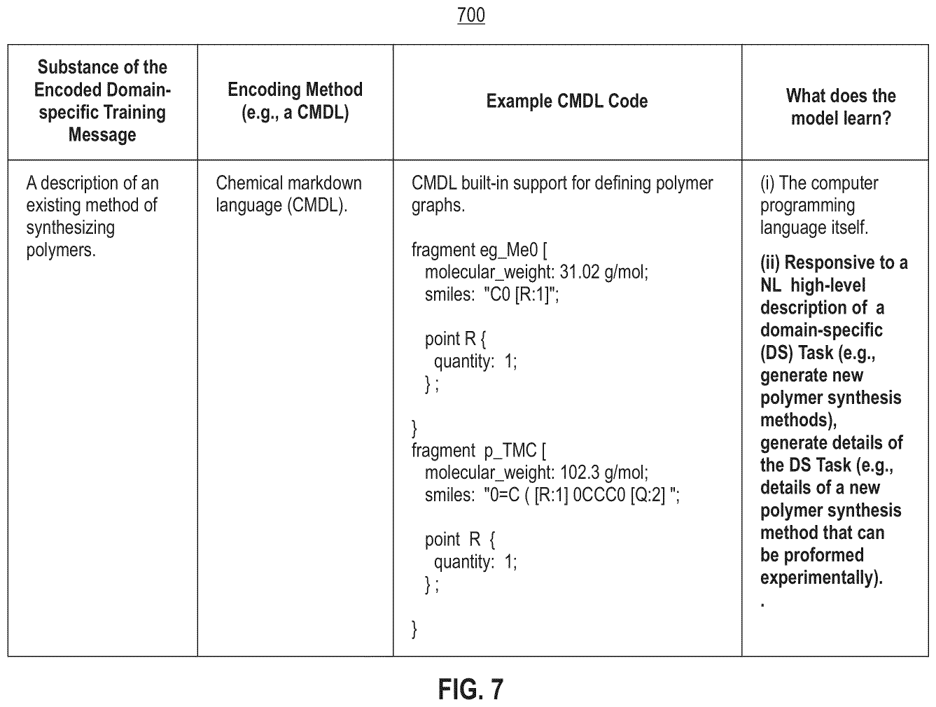

In addition to any one or more of the features described herein, embodiments of the invention leverage the ability of LLMs or similar AI models to ingest NL and computer programming language (or code). In conventional applications, an LLM is referred to as a code-generating LLM when it is trained on a more specialized dataset that includes code repositories, technical forums, coding platforms, documentation of various products and general web data that is useful for the purpose of performing various tasks related to generating computer code (e.g., table 600 shown in FIG. 6). Because code-generating LLMs can be integrated with an associated integrated development environment (IDE), they can fully grasp the context of code (comments, function names, and variable names). Embodiments of the invention, leverage the ability of LLMs to ingest code, not solely for the purpose of generating computer code, but for the additional purpose of understanding the underlying concepts described by the ingested code, then performing tasks that leverage the learned understanding of the underlying concepts described by the ingested code (e.g., table 700 shown in FIG. 7).

In addition to any one or more of the features described herein, the ML model comprises a generative model. In addition to any one or more of the features described herein, the encoded domain information comprises encoded synthetic data. In addition to any one or more of the features described herein, the encoded domain information represents one or more new material designs.

The above-described embodiments of the invention provide technical benefits and technical effects. For example, embodiments of the invention train a language model to ingest data/information that has been encoded in a language, and further train the language model to perform tasks (e.g., generative tasks) that leverage the ingested, language-encoded data/information. In some embodiments of the invention, the encoding language is a NL, a computer programming language, and/or a domain-specific computer programming language. After learning the features and structures of the encoding technique and the language-encoded data/information, the language model can leverage the learned features and structures to perform tasks, including specifically generative tasks (e.g., in a COM domain, generate or design a new polymer, or generate/design a new experiment to synthesize polymers).

Embodiments of the invention are also directed to computer systems and computer program products having substantially the same features and functionality as the computer-implemented methods described above.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The components/modules of the systems illustrated herein are depicted separately for ease of illustration and explanation. In embodiments of the invention, the functions performed by the components/modules can be distributed differently than shown without departing from the scope of the various embodiments of the invention describe herein unless it is specifically stated otherwise.

For convenience, some of the technical operations described herein are conveyed using informal expressions. For example, a machine learning model that is configured to analyze and process information having a given data structure can be described as the machine learning model “understanding” or “deriving meaning from” the information's data structure. As another example, a processor that has key data stored in its cache memory can be described as the processor “knowing” the key data. As a further example, a user sending a load-data command to a processor can be described as the user “telling” the processor to load data. It is understood that any such informal expressions in this detailed description should be read to cover, and a person skilled in the relevant art would understand such informal expressions to cover, the informal expression's corresponding more formal and/or technical description.

Various aspects of the present invention are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present invention to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present invention, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

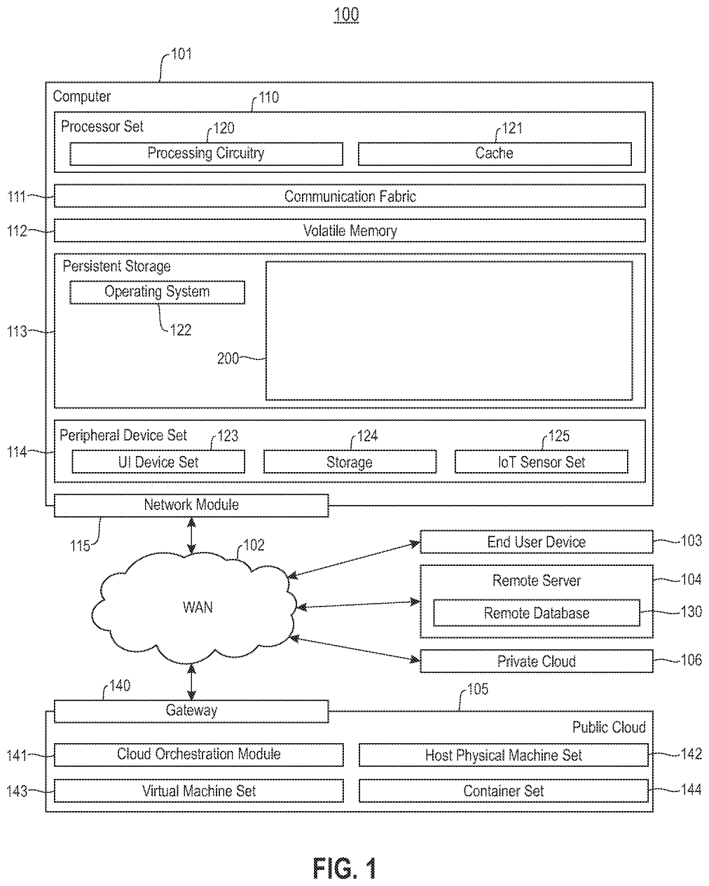

FIG. 1 depicts a computing environment 100 that contains an example of an environment for the execution of at least some of the computer code involved in performing the inventive methods, such as code block 200 operable to utilize novel code-based, domain-specific data structures to generate and implement machine learning models. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

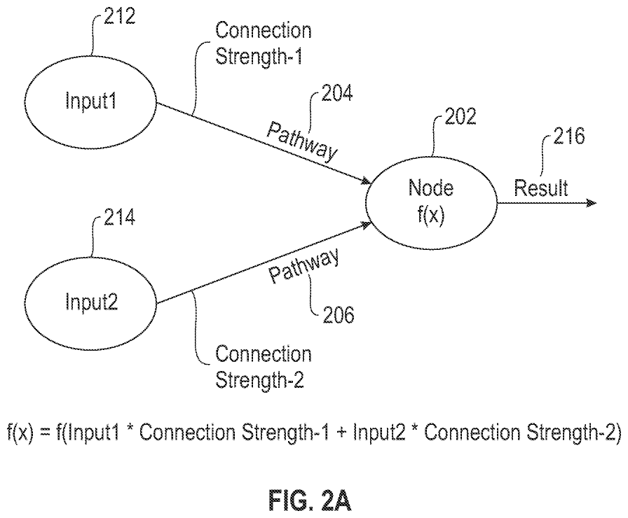

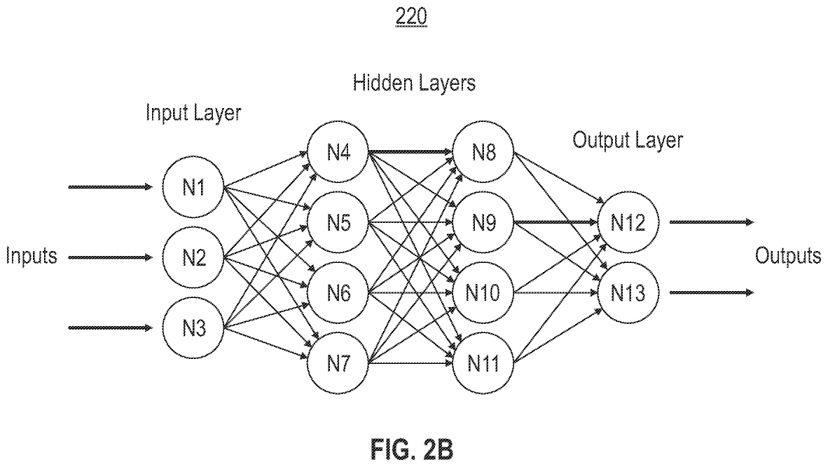

Embodiments of the invention can be implemented using NNs, which are a specific category of machines that can mimic human cognitive skills. In general, a NN is a network of artificial neurons or nodes inspired by the biological neural networks of the human brain. In FIG. 2A, the biological neuron is modeled as a node 202 having a mathematical function, f(x), depicted by the equation shown in FIG. 2A. Node 202 receives electrical signals from inputs 212, 214, multiplies each input 212, 214 by the strength of its respective connection pathway 204, 206, takes a sum of the inputs, passes the sum through a function, f(x), and generates a result 216, which may be a final output or an input to another node, or both. In the present specification, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 2B depicts a simplified example of a deep learning NN architecture (or model) 220. In general, NNs can be implemented as a set of algorithms running on a programmable computer (e.g., computer 101 and/or remote server 104 of the computing environment 100 shown in FIG. 1). In some instances, NNs are implemented on an electronic neuromorphic machine (e.g., the IBM®/DARPA SyNAPSE computer chip) that attempts to create connections between processing elements that are substantially the functional equivalent of the synapse connections between brain neurons. In either implementation, NNs incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a NN is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The NN is “trained” by performing multiple iterations of learning-based analysis on the real-world data vectors until patterns (or relationships) contained in the real-world data vectors are uncovered and learned.

NNs use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a NN can be used to perform a variety of tasks, two of the more common tasks are labeling (or classification) of real-world data and determining the similarity between segments of real-world data. Classification tasks often depend on the use of labeled datasets to train the NN to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Similarity tasks apply similarity techniques and (optionally) confidence levels (CLs) to determine a numerical representation of the similarity between a pair of items.

Returning again to FIG. 2B, the deep learning NN architecture/model 220 is organized as a weighted directed graph, where the artificial neurons are nodes (e.g., N1-N13), and where weighted directed edges (i.e., directional arrows) connect the nodes. The deep learning NN architecture/model 220 is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. Having multiple hidden layers indicates that the deep learning NN architecture/model 220 is a deep learning NN architecture/model. Each node is connected to every node in the adjacent layer by connection pathways, which are depicted in FIG. 2B as directional arrows each having its own connection strength. For ease of illustration and explanation, one input layer, two hidden layers, and one output layer are shown in FIG. 2B. However, in practice, multiple input layers, multiple hidden layers, and multiple output layers can be provided. When multiple hidden layers are provided, the deep learning NN architecture/model 220 can perform unsupervised deep-learning for executing classification/similarity type tasks.

Similar to the functionality of a human brain, each input layer node N1, N2, N3 of the deep learning NN architecture/model 220 receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathway into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The deep learning NN architecture/model 220 can be implemented as a feedforward NN or a recurrent NN. A feedforward NN is characterized by the direction of the flow of information between its layers. In a feedforward NN, information flow is unidirectional, which means the information in the model flows in only one direction—forward—from the input nodes, through the hidden nodes (if any) and to the output nodes, without any cycles or loops. In contrast to recurrent NNs, which have a bi-directional information flow, feedforward NNs are trained using the backpropagation method.

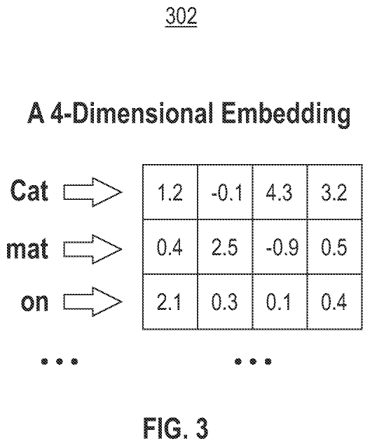

Some embodiments of the invention utilize and leverage embedding spaces. An embedding is a relatively low-dimensional space into which high-dimensional vectors can be translated. Embeddings make it easier to apply machine learning to large inputs like sparse vectors representing words. FIG. 3 illustrates the concept of embedding using an example word embedding 302. In general, NN models take vectors (i.e., an array of numbers) as inputs. Where the inputs are natural language (NL) symbols, token/word vectorization refers to techniques that extract information from the NL symbol corpus and associate to each word of the NL symbol corpus a vector using a suitable vectorization algorithm that takes into account the word's context.

Embeddings are a way to use an efficient, dense vector-based representation in which similar words have a similar encoding. In general, an embedding is a dense vector of floating-point values. In a word embedding, words are represented by dense vectors where a vector represents the projection of the word into a continuous vector space. The length of the vector is a parameter that must be specified. However, the values of the embeddings are trainable parameters (i.e., weights learned by the model during training in the same way a model learns weights for a dense layer). More specifically, the position of a word within the vector space of an embedding is learned from text in the relevant language domain and is based on the words that surround the word when it is used. The position of a word in the learned vector space of the word embedding is referred to as its embedding.

FIG. 3 depicts an example diagram of a word embedding 302 in an English language domain. As shown in FIG. 3, each word is represented as a 4-dimensional vector of floating-point values. Another way to think of the word embedding 302 is as a “lookup table.” After the weights have been learned, each word can be encoded by looking up the dense vector it corresponds to in the table. The embedding layer (or lookup table) maps from integer indices (which stand for specific words) to dense vectors (their embeddings). The dimensionality (or width) of the embedding is a parameter that can be selected to match the task for which it is designed. When an embedding layer is created, the weights for the embeddings are randomly initialized (just like any other layer). During training, the weights are gradually adjusted via back-propagation training techniques. Once trained, the learned word embeddings will roughly encode similarities between words (as they were learned for the specific problem on which the model is trained). The general techniques used in word embedding apply to embeddings in other domains, including domains used in embodiments of the invention.

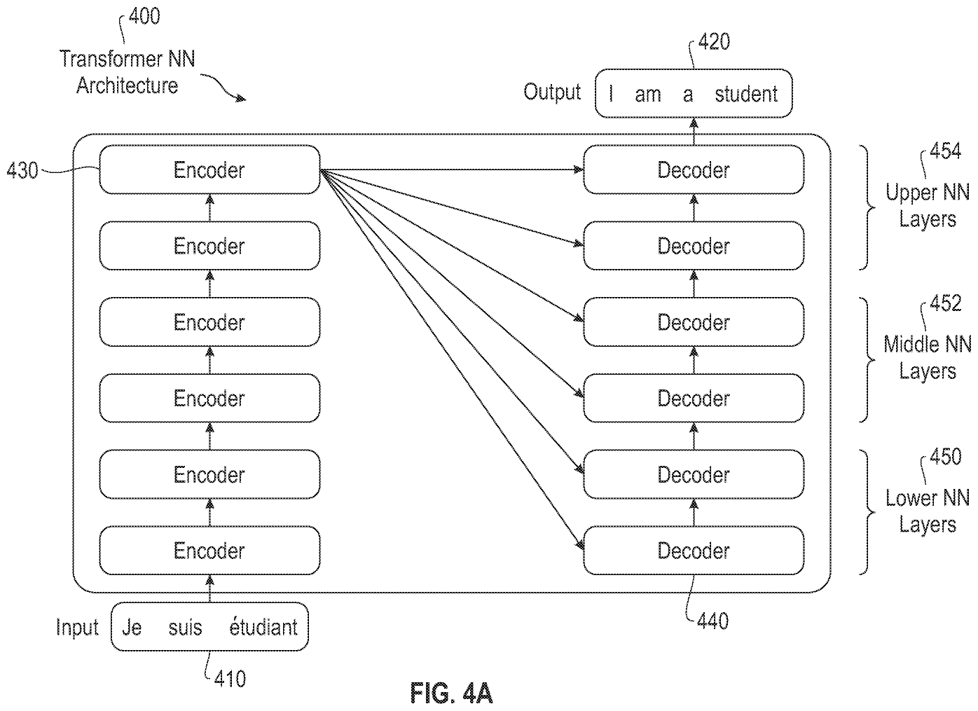

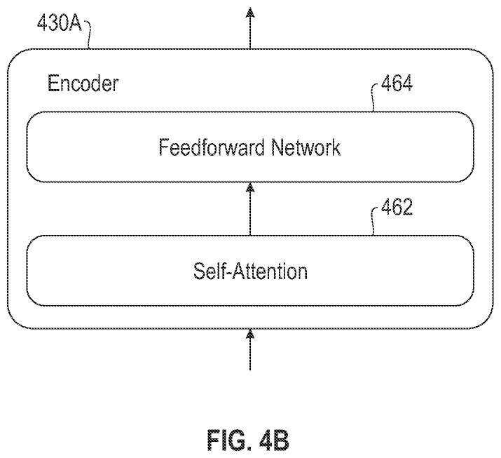

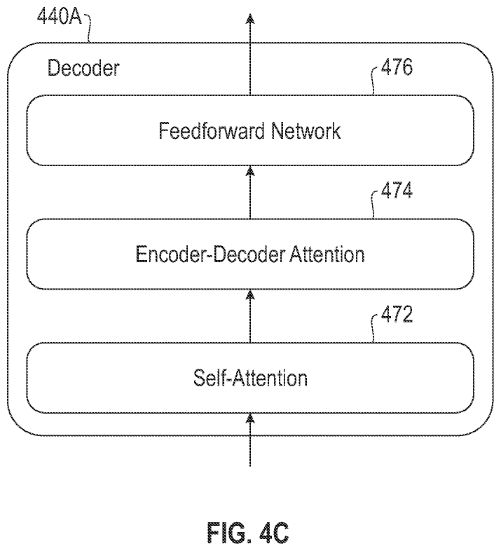

FIGS. 4A, 4B and 4C depict a non-limiting example of various aspects of a transformer NN architecture 400 that can be utilized to implement some aspects of the invention. More specifically, FIG. 4A depicts a simplified block diagram illustrating a non-limiting example of the transformer NN architecture 400; FIG. 4B depicts a simplified block diagram illustrating a non-limiting example of an encoder 430A of the transformer NN architecture 400; and FIG. 4C depicts a simplified block diagram illustrating a non-limiting example of a decoder 440A of the transformer NN architecture 400.

The transformer NN architecture 400 includes tokenization and embedding features. In embodiments of the invention, the transformer NN architecture 400 converts text and other data to vectors and back using tokenization, positional encoding, and embedding layers. The transformer NN architecture 400 is a sequence-to-sequence NN architecture in which input text is encoded with tokenizers to sequences of integers called input tokens. Input tokens are mapped to sequences of vectors (e.g., word embeddings) via embeddings layers. Output vectors (embeddings) can be classified to a sequence of tokens, and output tokens can then be decoded back to text.

More generally, tokenization is cutting input data into parts (symbols) that can be mapped (embedded) into a vector space. For example, input text is split into frequent words, which is an example of transformer tokenization. In some instances, special tokens can be appended to the sequence (e.g., class tokens) used for classification embeddings. Positional encodings add token order information. Self-attention and feed-forward layers are symmetrical with respect to the input so positional information is provided about each input token so positional encodings or embeddings are added to token embeddings in transformer encodings. Accordingly, embeddings are learned and/or trained.

As shown in FIG. 4A, the transformer NN architecture 400 includes a series or sequence of encoders 430 and a sequence of decoders 440 configured and arranged as shown. The encoders 430 and decoders 440 are organized around groups of layers including lower NN layers 450, middle NN layers 452, and upper NN layers 454. The transformer NN architecture 400 receives an input 410 (e.g., a sentence in French), uses the encoders 430 and the decoders 440 to perform a task (e.g., translating a French sentence to an English sentence), and, responsive to the input 410 generates an output 420 (e.g., an English translation of a French sentence). More specifically, the encoders 430 are configured and arranged to take the input 410, for example a sentence (i.e., sequences) written in French, and mapping it to high-dimensional representation(s). The encoders 430 are configured to “learn” the parts of the input 410 (i.e., the sequence) that are important and pass them to the high-dimensional representation, and the less-important aspects of the input 410 (e.g., the sequence) are left out. At this stage, the high-dimensional representation cannot be easily understood because there are no semantics involved and the complete mapping has not yet been learned.

The decoders 440 are configured to convert the high-dimensional representation into the output 420, which, in this example, is a sequence (e.g., a sequence written in English). Utilizing the encoders 430 and the decoders 440 allows models to be built that can transduce (i.e., map without losing semantics) “one way” into “another,” e.g., French into English. By training the encoders 430 and the decoders 440 together, a sequence-to-sequence model is created. A sequence-to-sequence model is capable of ingesting a sequence of a particular kind and outputting another sequence of another kind.

In embodiments of the invention, the transformer NN architecture 400 (also known as a generative language model) can be trained to perform the various tasks described herein. In the transformer NN architecture 400, the encoders 430 can be organized in layers (e.g., lower NN layers 450, middle NN layers 452, and upper NN layers 454) that process the input 410 iteratively one layer after another; and the decoders 440 can also be organized in corresponding layers (e.g., lower NN layers 450, middle NN layers 452, and upper NN layers 454) that do the same thing to the output of the last encoder 430. The function of each encoder 430 in a given layer is to process its input to generate encodings that contain information about which parts of the inputs are relevant to each other. The encoder 430 in one layer passes its set of encodings to the encoder 430 in the next layer as inputs. Each decoder 440 in a corresponding layer does the opposite, taking the output from the last encoder 430 and processing them, using their incorporated contextual information, to generate the output 420. To achieve this, each encoder 430 of a given layer makes use of an attention mechanism (e.g., self-attention 462 shown in FIG. 4B). In the context of NNs, an attention mechanism is a technique that electronically mimics human cognitive attention. The effect enhances the important parts of the input data and fades out the rest such that the NN devotes more computing power on that small but important part of the data. The part of the data that is more important than other parts of the data depends on the context and is learned through training data by gradient descent. Thus, the attention mechanism of the transformer NN architecture 400 weighs the relevance of every other input and draws information from them accordingly to produce the output. Each decoder 440 can include an additional attention mechanism (e.g., self-attention 472 and encoder-decoder attention 474 shown in FIG. 4C) that draws information from the outputs of previous decoders 440 before the current decoder 440 draws information from the encodings. The encoders 430 and the decoders 440 each include a feedforward network (e.g., feedforward network 464 shown in FIG. 4B, and feedforward network 476 shown in FIG. 4C) for additional processing of the outputs, and also contain residual connections and layer normalization steps.

FIG. 4B depicts a simplified block diagram illustrating a non-limiting example of how the encoder 430 (shown in FIG. 4A) can be implemented as the encoder 430A; and FIG. 4C depicts a simplified block diagram illustrating a non-limiting example of how the decoder 440 (shown in FIG. 4A) can be implemented as the decoder 440A. The encoders 430 are very similar to each other, and the decoders 440 are very similar to each other, as well. As shown in FIG. 4B, each encoder 430A includes two sub-layers, namely, a self-attention 462 and a feedforward network 464. The inputs to the encoder 430A first flow through the self-attention 462, which helps the encoder 430A look at other parts of the input 410 as it encodes a specific word. The decoder 440A shown in FIG. 4C has a corresponding self-attention 472 and feedforward network 476 that perform substantially the same functions in the decoder 440A as the self-attention 462 and the feedforward network 464 perform in the encoder 430A. The decoder 440A further includes encoder-decoder attention 474 that helps the decoder 440A focus on relevant parts of the input sentence.

Turning now to an overview of issues addressed by embodiments of the invention, NL processing (NLP) is a field of computer science that uses algorithms and computer systems to process human languages such as English. Human language is often referred to as NL. In general, NL refers to language that has been developed by humans over time as a method of communicating between people, rather than language that has been created for communication between non-human entities such as computers.

NLP is used in systems that allow humans to more effectively interface with data repositories that store electronic information, including, for example, electronic versions of human readable electronic documents. NLP interfaces/systems have been developed to perform a variety of human/data interface tasks such as text-searching and/or text-matching, as well as more sophisticated tasks such as document/data content analysis (DCA). In general, DCA systems conduct computer-assisted research and analysis using the categorization and classification of speech, written text, interviews, images, or other forms of electronically stored information. A known type of DCA is so-called a “question and answer (QA) system” that use NLP and machine learning algorithms to cognitively analyze a variety of stored electronic information in order to provide answers to open-ended NL questions.

In known implementations of DCA and/or QA systems, training data is used to train machine learning models (or classifiers) to perform the systems' overall task(s). This training stage requires that training data, as well as post-training real world data-under-analysis, is translated into numerical representations that can be recognized and manipulated by the DCA system's machine learning model. Examples of suitable numerical representations of the data include tokens, vectors, and the like. Translating training data and/or post-training real world data-under-analysis into such numerical representations can be a processing bottleneck in known DCA/QA systems. This is particularly true when the training data and/or post-training real world data-under-analysis are unstructured and/or semi-structured.

Electronic information can be categorized as unstructured, semi-structured, or structured. Unstructured electronic information is not organized in a uniform format (i.e., it is not labeled or otherwise organized) and can include text, images, video, and audio material. Similarly, semi-structured electronic information includes some form of organization (e.g., some semantic labels/tags) but the chosen organization method lacks consistency, is not standardized, or has some other deficiency. In contrast, structured electronic information is information that has been well-organized and arranged in a systematic, easily accessible way, including, for example, attaching consistent labels to the electronic information and/or organizing the electronic information into an addressable repository or a database.

The difficulty with using computers to analyze the various types of unstructured, structured or semi-structured electronic information is even more pronounced when the electronic information is from a domain (e.g., math, chemistry, material science, molecular biology, and the like) having specialized language, notations, symbols, relationships, properties, and interactions. A non-limiting example of such a domain is a “chemistry of materials” (COM) domain that uses specialized language, notations, symbols, relationships, properties, interactions, and the like to describe the chemical structures, chemical properties, and chemical interactions between and among materials. Two examples of how COM domain data/information are represented in electronic documents are shown in FIGS. 5A and 5B. FIG. 5A depicts a simplified molecular input line entry system (SMILES) molecular representation in the form of a string representation. SMILES is an encoding format that is used to translate a chemical's three-dimensional structure into a string of symbols that can be understood by computer software. However, although computer software can ingest (e.g., use data translation processes to convert data/information into a form that is machine-readable) and understand SMILES strings, it is difficult for humans to interpret SMILES strings. Also, SMILES strings simply provide an encoding for representing actual materials, but SMILES strings provide no assistance with encoding the interactions/relationships between the materials in a manner that enables computer systems and computer algorithms to efficiently and effectively ingest and interpret COM domain data/information.

FIG. 5B is an example of a COM domain experimental protocol 500 that can be described in, for example, a journal article using NL. Although the NL presentation of the COM domain experimental program 500 attempts to present NL descriptions of material interactions, the domain-specific terminology (e.g., methoxy-terminated poly (ethylene glycol)) is cumbersome to use consistently in writing. An example of such domain-specific terminology is IUPAC (international union of pure and applied chemistry) nomenclature. The purpose of the IUPAC system of nomenclature is to establish an international standard of naming compounds to facilitate communication. The goal of the IUPAC system is to give each structure a unique and unambiguous name, and to correlate each name with a unique and unambiguous structure. IUPAC nomenclature is based on naming a molecule's longest chain of carbons connected by single bonds, whether in a continuous chain or in a ring. All deviations, either multiple bonds or atoms other than carbon and hydrogen, are indicated by prefixes or suffixes according to a specific set of priorities. However, because IUPAC notations are extremely complex and cumbersome to use consistently in writing, domain practitioners have developed their own shorthand notations, acronyms and other substitute terminology and used these in their publications. Thus, it is extremely difficult for computer systems and computer algorithms to keep track of and effectively utilize such constantly evolving and inconsistently used terminology.

Accordingly, there is a need in the art for a consistent structured data/information format (i.e., data structure) that facilitates computer processing and analysis of data/information, particularly where the computer processing/analysis tasks to be performed on the data/information are associated with a specific domain.

Embodiments of the invention address the above-described need by providing computer-implemented methods, computer systems, and/or computer program products operable to utilize novel programming-language-based data structures to develop and implement various types of machine learning models, including specifically generative machine learning models. More specifically, embodiments of the invention provide a data/information encoding format operable to represent various aspects of data/information and associated data/information analysis techniques, including specifically domain-specific data/information and/or associated domain-specific data/information analysis techniques. In general, encoding is a process of converting data from one format into another format that is suitable for a number of computer-based information processing operations. Encoding is also used to reduce the size of audio and video files. Encoding can be distinguished from encryption techniques, which are configured and arranged to hide content.

In domain-specific applications of embodiments of the invention, the various aspects of the data/information and/or associated data/information analysis techniques are domain-specific and include but are not limited to individual domain elements (e.g., a chemical compound in a COM domain), domain element properties (e.g., melting points and the like), domain-specific processing operations (e.g., exposing domain element A to gas B in a vacuum for 20 minutes), domain-specific processing rules (e.g., use plus symbol to convey mixing two elements), and other domain-specific attributes represented in a consistent and structured domain-specific encoding format that can be ingested and processed using a variety of computing systems and computer algorithms. Non-limiting examples of the domain-specific data/information and/or the domain-specific data/information analysis techniques that can be encoded and analyzed using embodiments of the invention include the example SMILES string shown in FIG. 5A, as well as the NL description of a COM-related experimental protocol 500 shown in FIG. 5B.

The data/information encoding format used in accordance with aspects of the invention is configured and arranged to take on the representation-based attributes of a language. The most common example of language is the many spoken and/or written languages humans use to communicate. Human language is often referred to as NL. In general, NL refers to language that has been developed by humans over time as a method of communicating between people rather than language that has been created for communication between non-human entities such as computers. Language is at the core of all forms of human and technological communications. Language provides the words, semantics and grammar needed to convey ideas and concepts.

In some embodiments of the invention, the above-described data/information encoding format is configured and arranged to take on the representation-based attributes of a computer programming language. In general, a computer programming language is a specialized “language” configured and arranged to express a set of detailed instructions for a digital computer. Such instructions are referred to generally as computer code and can be executed directly when they are in the computer. The computer code can be in a variety of forms, including a manufacturer-specific numerical form known as machine language; and/or a corresponding assembly language that results from a simple substitution process applied to machine language; and/or after translation from some “higher-level” language. Machine and assembly languages are “low-level” in that they require a programmer to manage explicitly all of a computer's idiosyncratic features of data storage and operation. In contrast, higher-level languages shield a programmer from worrying about such considerations and provide a notation that is more easily written and read by programmers. A core skill of any computer programmer is learning and/or mastering the relevant computer programming languages the computer programmer will use to write computer code.

Similar to NL, a computer programming language utilized in accordance with aspects of the invention includes its own syntax. Syntax is a set of rules that prescribe what arrangements of characters create a valid statement in a language. NL and programming languages are both dependent on syntax. To use either type of language effectively, it is necessary to know how to fit elements together to achieve the goal. In the case of a NL, this goal is successful human or machine communication. In the case of a computer programming language, a goal is to issue a set of directives that a computer can read and understand. Examples of what programming syntax can determine include whether lower-case or upper-case characters are used; how code comments are notated; how whitespace is used; and how the relationships between statements (individual commands issued to the computer) are indicated.

In accordance with aspects of the invention, the computer code and associated syntax are not used in embodiments of the invention to instruct the computer to perform an action, per se. Instead, the computer code and associated syntax are used in embodiments of the invention to represent in a computer-code format the various aspects of data/information and associated data/information analysis techniques, including specifically domain-specific data/information and/or associated domain-specific data/information analysis techniques. Non-limiting examples of the domain-specific data/information and/or the domain-specific data/information analysis techniques that can be encoded as computer code in a computer programming language and analyzed using embodiments of the invention include the example SMILES string shown in FIG. 5A, as well as the NL COM-related experimental protocol 500 shown in FIG. 5B.

FIG. 6 depicts a table 600 that summarizes a known use of a machine learning model to learn a computer programming language (e.g., Python®) and use the learned computer programming language to write computer code. More specifically, table 600 depicts four columns labeled, from left to right, as “Substance of the Encoded Training Message,” “Encoding Method (e.g., Python®),” “Example Python® Code,” and “What does the model learn?”. The three leftmost columns of table 600 summarize the data and encoding methods used to train/generate the machine learning model, and the rightmost column summarizes what the machine learning model actually learns to do. The machine learning model is trained/generated using multiple instances of computer programming code written in a particular computer programming language. The machines learning model uses model learning techniques to extract learning from the training instances. In the example shown in table 600, the “Substance of the Encoded Training Message” is an instruction that tells the computer to perform one or more computer tasks; the “Encoding Method” is the Python® computer programming language; and an example of the Python® code used as the “Encoded Training Message” is a print instruction shown as “Print ‘Hello, world!’”. As shown in the rightmost column of table 600, the machine learning model, during the training process, actually learns the computer programming language itself (e.g., Python®), and further learns how to, responsive to a NL description of Task-A (e.g., print a specific phrase), write computer programming code in the learned computer programming language that instructs a computer to perform Task-A.

FIG. 7 depicts a table 700 that summarizes a non-limiting example of how a domain-specific computer programming language can be used, in accordance with embodiments of the invention, as a programming-language-based encoding technique. The programming-language-based encoding technique is operable to encode data/information that is used to train/generate a machine learning model to perform tasks such as generative tasks. In accordance with aspects of the invention, the generative tasks include creating synthetic data/information that mimics the “Substance of the Encoded Domain-specific Training Message” under the leftmost column of the table 700. In general, synthetic data/information is artificially created data/information that is designed to replicate the statistical characteristics and correlations of real-world, raw data/information (e.g., replicate the statistical characteristics and correlations of the NL COM domain experimental protocol 500 shown in FIG. 5B). Table 700 depicts four columns labeled, from left to right, “Substance of the Encoded Domain-specific Training Message,” “Encoding Method (e.g., CMDL),” “Example CMDL Code,” and “What does the model learn?”. The three leftmost columns of table 700 summarize the data and encoding methods used to train/generate the machine learning model, and the rightmost column summarizes what the machine learning model actually learns to do. The machine learning model is trained/generated using multiple instances of domain-specific data/information (e.g., the NL COM domain experimental protocol 500 shown in FIG. 5B) encoded in computer programming code (e.g., chemical markdown language (CMDL) code) written in a particular computer programming language (e.g., CMDL). The machines learning model uses model learning techniques to extract learning from the training instances. As shown in table 700, the “Substance of the Encoded Domain-specific Training Message” is a description of an existing method of synthesizing polymers; the “Encoding Method” is the chemical markdown language (CMDL); and an example of the CMDL code used as the “Encoded Domain-specific Training Message” is the CMDL code shown in table 700 under the heading “Example CMDL code” for defining polymer graphs. As shown in the rightmost column of table 700, the machine learning model, during the train process, actually learns the computer programming language itself (e.g., Python®), and further learns how to, responsive to a NL description of a domain-specific (DS) Task (e.g., generate new polymer synthesis methods), generate details of a new polymer synthesis method that can be performed experimentally in a lab or virtually using a computer simulation system. Additional examples of the “NL high-level description of a DS task” described in the rightmost column of table 700 are shown by any combination of one or more of the input representations 1110A, 1110B, 1110C, 1210A, 1210B, 1310 (shown in FIGS. 11, 12, 13). Additional examples of the generated “details of the DS task” described in the rightmost column of table 700 are shown by any combination of one or more of the output representations 1120A, 1120B, 1120C, 1220A, 1220B, 1320 (shown in FIGS. 11, 12, 13).

It can be seen from a comparison of table 600 with table 700 that embodiments of the invention leverage the ability of models to ingest NL and computer programming language (or code). In the code-generation application shown in table 600, the relevant machine learning model is trained on a specialized dataset that includes code repositories, technical forums, coding platforms, documentation of various products and general web data that is useful for the purpose of performing various tasks related to generating computer code. Because code-generating machine learning models can be integrated with an associated integrated development environment (IDE), they can fully grasp the context of code (comments, function names, and variable names). Table 700, which embodies aspects of the invention, also leverages the ability of machine learning models to ingest code, not solely for the purpose of generating computer code as shown in table 660, but instead for the further purpose of learning the statistical characteristics and correlations of the underlying concepts described by the ingested code (i.e., the “Substance of the Encoded Domain-specific Training Message”), then performing tasks that leverage the learned statistical characteristics and correlations of the underlying concepts described by the ingested code to perform generative tasks, such as generating synthetic data/information in the specific domain.

In some embodiments of the invention, as depicted by the summarization shown in table 700 of FIG. 7, the computer programming language can be implemented as a domain-specific programming language (DSPL) (or domain-specific computer programming language). A DSPL is a programming language meant for use in the context of a particular domain (e.g., COM, mathematics, fluid dynamics, and the like). In contrast, a general-purpose programming language (GPPL) is built to be used for a wide range of problems and applications. A DSPL is created for a limited sphere of applicability and use, but it is powerful enough to represent and address the problems and solutions in that sphere. A GPPL is created with generic constructs that potentially are usable for any problem, solution, or need. In a conventional application of DSPLs, the DSPL is used by a computer programmer to create computer code that can be configured to execute an algorithm that instructs the computer to perform various analysis-related operations.

In embodiments of the invention, the DSPL is configured to enable the creation and definition of variables within the DSPL computer code. The defined variables can identify name formats of the variable. For example, a DSPL for a COM domain in accordance with embodiments of the invention can be configured to define a variable and name it “hydrogen.” The variable “hydrogen” can be further defined within the DSPL code to include the SMILES string, IUPAC notation, slang terms, and like used in COM literature to represent the variable labeled in the DSPL as “hydrogen.” The DSPL can be further configured to associate features of the variable (e.g., the variable's molecular weight, boiling point, etc.) with the variable. As an examples, in accordance with aspects of the invention, variables, variable definitions, and syntax of a DSPL can be used to represent in a DSPL computer code the SMILES string shown in FIG. 5A, as well as the NL experimental protocol 500 shown in FIG. 5B.

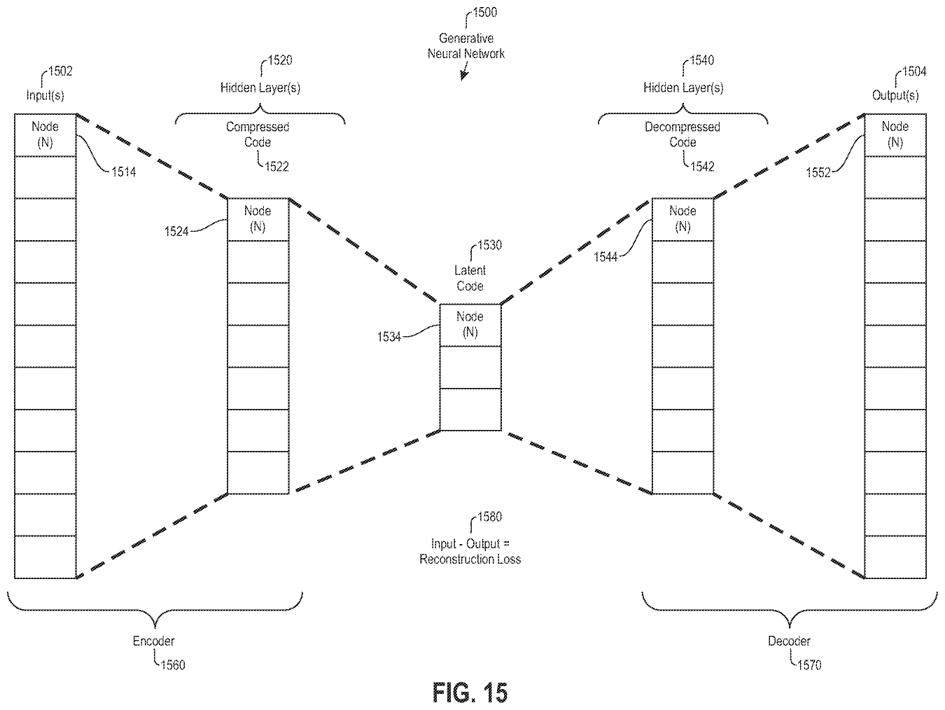

As previously noted, a consistent and structured domain-specific encoding format in accordance with embodiments of the invention can be ingested (e.g., using data translation processes to convert data/information into a form that is machine-readable) by a variety of computing systems and computer algorithms. For example, the NL COM domain experimental protocol 500 (shown in FIG. 5B) encoded in the above-described DSPL can be ingested into a neural network (NN), where the NN can be implemented as, for example, a language model. In some embodiments of the invention, the language model(s) can be implemented using a variety of encoder-decoder architectures, including but not limited to sequence-to-sequence architectures, RNN (recurrent neural network) architectures, and various transformer model architectures (or generative language model architectures). In general, an encoder-decoder language model architecture (e.g., the generative neural network (GNN) 1500 shown in FIG. 15) includes an encoder and a decoder, where the encoder is configured and arranged to take input sequences, for example sentences (i.e., sequences) written in German, and map them to high-dimensional representation. The encoder is configured to “learn” the parts of the input sequences that are important and pass them to the high-dimensional representation, and the less-important aspects of the input sequences are left out. At this stage, the high-dimensional representation cannot be easily understood because there are no semantics involved and the complete mapping has not yet been learned. The decoder is configured to convert the high-dimensional representation into another sequence, which, in this example, is an output sequence (e.g., a sequence written in English). Utilizing an encoder and a decoder allows language models to be built that can transduce (i.e., map without losing semantics) “one way” into “another,” e.g., German into English. By training the encoder and the decoder together, a sequence-to-sequence language model is created. A sequence-to-sequence language model is capable of ingesting a sequence of a particular kind and outputting another sequence of another kind.

In addition to language models, embodiments of the invention can be implemented using large language models (LLMs). An evolution of language models is LLMs, which dramatically expand the data used for training and inference, and which provide a massive increase in the capabilities of the resulting model. While there is no universally accepted figure for how large the data set for training needs to be, an LLM typically has about one billion or more parameters. Parameters are a machine learning term for the variables present in the model on which it was trained that can be used to infer new content. An LLM uses deep learning techniques and massively large data sets to understand, summarize, generate and predict new content. The term generative AI also is closely connected with LLMs, which are a type of generative AI that has been specifically architected to help generate language-based content.

LLMs used in embodiments of the invention can be trained using multiple steps, usually starting with an unsupervised learning approach in which the LLM is trained on unstructured data and/or unlabeled data. The benefit of training on unlabeled data is that there is often vastly more data available. At this stage, the LLM begins to derive relationships between different words and concepts. A subsequent step for some LLMs is training and fine-tuning with a form of self-supervised learning. Here, some data labeling has occurred, thereby assisting the LLM to more accurately identify different concepts. The LLM undertakes deep learning as it proceeds through the transformer neural network process. The transformer model architecture enables the LLM to understand and recognize the relationships and connections between words and concepts in the language it is attempting to learn using a self-attention mechanism. A self-attention mechanism is operable to assign a score, commonly referred to as a weight, to a given item (called a token) in order to determine the relationship. After the LLM has been sufficiently trained to ingest the language-based encoding format described herein (and more specifically, the computer-programming-language-based encoding format described herein), a basis exists on which the LLM can be used for practical purposes. By querying the LLM with a prompt (e.g., any combination of one or more of the input representations 1110A, 1110B, 1110C, 1210A, 1210B, 1310 shown in FIGS. 11, 12, 13 and described in greater detail subsequently herein), the LLM can use its learned language to generate a response, which could be an answer to a question, newly generated text, summarized text, or, in the case of a COM domain, a new polymer design or a new experiment to synthesize polymers (e.g., any combination of one or more of the output representations 1120A, 1120B, 1120C, 1220A, 1220B, 1320 shown in FIGS. 11, 12, 13 and described in greater detail subsequently herein).

Embodiments of the invention leverage the ability of LLMs or similar AI models to ingest NL and computer programming language (or code). In conventional applications, an LLM is referred to as a code-generating LLM when it is trained on a more specialized dataset that includes code repositories, technical forums, coding platforms, documentation of various products and general web data that is useful for the purpose of performing various tasks related to generating computer code (e.g., table 600 shown in FIG. 6). Because code-generating LLMs can be integrated with an associated integrated development environment (IDE), they can fully grasp the context of code (comments, function names, and variable names). Embodiments of the invention, leverage the ability of LLMs to ingest code, not solely for the purpose of generating computer code, but for the additional purpose of understanding the underlying concepts described by the ingested code, then performing tasks that leverage the learned understanding of the underlying concepts described by the ingested code (e.g., table 700 shown in FIG. 7).

Accordingly, embodiments of the invention train a language model to ingest data/information that has been encoded in a language, and further train the language model to perform tasks (e.g., generative tasks) that leverage the ingested, language-encoded data/information. In some embodiments of the invention, the encoding language is a NL, a computer programming language, and/or a domain-specific computer programming language. After learning the features and structures of the encoding technique and the language-encoded data/information, the language model can leverage the learned features and structures to perform tasks, including specifically generative tasks (e.g., in a COM domain, generate or design a new polymer, or generate/design a new experiment to synthesize polymers).

In some embodiments of the invention, an LLM trained in accordance with aspects of the invention can be validated by using a domain-specific compiler to verify the domain-specific syntax of outputs generated by the trained LLM. In some embodiments of the invention, version tools and control tools of the domain specific computer programming language are used to update the domain specific computer programming language and improve the processes used to generate/train the domain specific computer programming language. In some aspects of the invention, the information that can be encoded using embodiments of the invention can be multi-modal information, including, for example, graphs, charts, plots, images, video, FID (free induction decay) spectra, and the like.

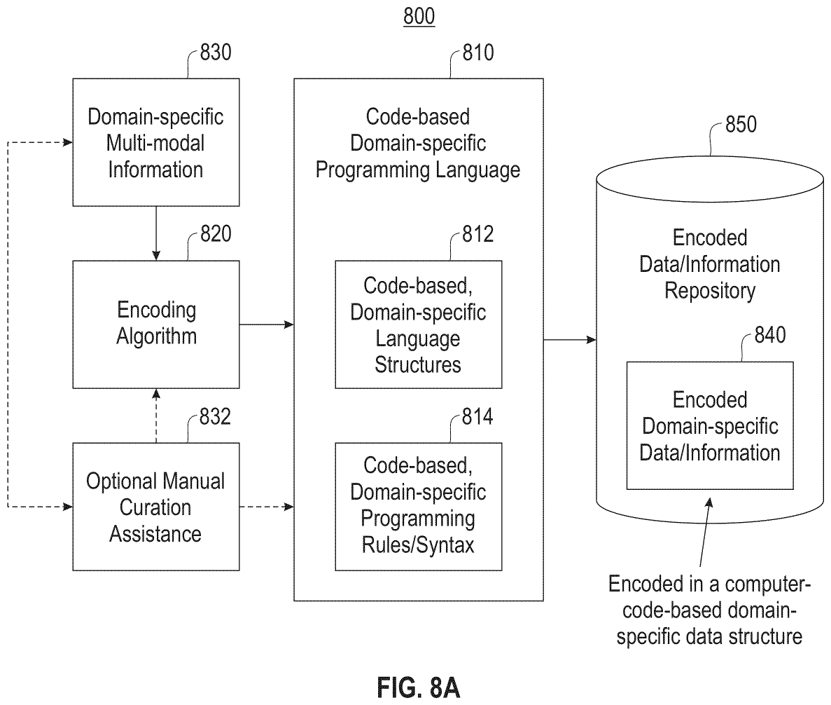

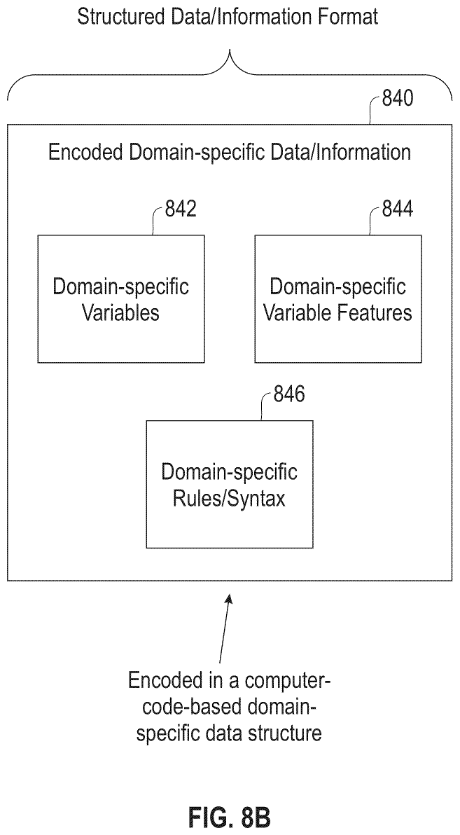

Turning now to a more detailed description of aspects of the invention, FIG. 8A depicts a simplified block diagram illustrating a non-limiting example of a programming language encoding system 800 in accordance with aspects of the invention. As shown, the programming language encoding system 800 includes an encoding algorithm 820 electronically coupled to a code-based domain-specific programming language (CDPL) module 810, configured and arranged as shown. In accordance with embodiments of the invention, the CDPL module 810 is further electronically coupled to an encoded data/information repository 850, which is operable to store encoded domain-specific data/information 840 generated using the CDPL of the CDPL module 810. In accordance with embodiments of the invention, the CDPL module 810 includes a code-based domain-specific language (CDL) structures module 812 and a code-based domain-specific programming (CDP) rules/syntax module 814. In accordance with embodiments of the invention, the encoding algorithm 820 is operable to convert domain-specific multi-modal (DM) information 830 into the encoded domain-specific data/information 840 using the CDPL of the CDPL module 810. In embodiments of the invention, the DM information 830 is multi-modal in that it can take a variety of formats, including, for example, graphs, charts, plots, images, video, FID (free induction decay) spectra, and the like. Non-limiting examples of the various forms the DM information 830 can take include, but are not limited to, the example SMILES string shown in FIG. 5A, as well as the NL COM-related experimental protocol 500 shown in FIG. 5B. In some embodiments of the invention, the encoding algorithm 820 can be configured and arranged to automatically work with the CDPL module 810 to perform the encoding that generates the encoded domain-specific data/information 840 without substantial manual intervention. In some embodiments of the invention, the encoding algorithm 820 can be configured and arranged to receive optional manual curation assistance 832 in working with the CDPL module 810 to perform the encoding that generates the encoded domain-specific data/information 840. In some embodiments of the invention, the optional manual curation assistance 832 can include a subject matter expert reviewing encodings generated by encoding algorithm 820 and the CDPL module 810 and making corrections to the generated encodings that the subject matter expert deems necessary. In some embodiments of the invention, the encoding algorithm 820 can be bypassed, and the optional manual curation assistance 832 can include a subject matter expert that works directly through the CDPL module 810 to encode the DM information 830 into the CDPL to generate the encoded domain-specific data/information 840.

In accordance with embodiments of the invention, CDPL structures module 812 is configured to enable the creation and definition of variables within the CDPL of the CDPL module 810. The defined variables can identify name formats of the variable(s). For example, a CDPL for a COM domain in accordance with embodiments of the invention can be configured to define a variable and name it “hydrogen.” The variable “hydrogen” can be further defined within the DSPL code to include the SMILES string, IUPAC notation, slang terms, and like used in COM literature to represent the variable labeled in the CDPL as “hydrogen.” The CDPL structures module 812 can be further configured to associate features of the variable (e.g., the variable's molecular weight, boiling point, etc.) with the variable. As an examples, in accordance with aspects of the invention, variables, variable definitions of the CDPL of the CDPL module 810 can be used to represent in CDPL computer code to include the SMILES string shown in FIG. 5A, as well as the COM-based NL experimental protocol 500 shown in FIG. 5B.

In accordance with embodiments of the invention, CDP rules/syntax module 814 is configured to enable the creation and definition of rules/syntax used in the CDPL of the CDPL module 810. The rules/syntax of the CDP rules/syntax module 814 are a set of rules that prescribe what arrangements of characters create a valid statement in the CDPL. In general, programming languages are dependent on syntax. To use CDPL effectively, it is necessary to know how to fit elements together to achieve the goal. In the case of the CDPL of the CDPL module 810, a goal is to issue a set of directives that a machine learning model can learn to read and understand. Examples of what programming language syntax can determine include whether lower-case or upper-case characters are used; how code comments are notated; how whitespace is used; and how the relationships between statements (individual commands issued to the computer) are indicated.

In embodiments of the invention, the encoded data/information repository 850 can be implemented as a searchable database operable to organize and store data from various sources in segments or regions of the encoded data/information repository 850. The encoded data/information repository 850 can be any form of database, including but not limited to, relational SQL databases, noSQL unstructured databases, unstructured data lakes, time-series databases, and the like. In some embodiments of the invention, the encoded data/information repository 850 can include features and functionality of a relational database operably controlled by the computing environment 100 (shown in FIG. 1). In general, a database is a means of storing information in such a way that information can be retrieved from it, and a relational database presents information in tables with rows and columns. A table is referred to as a relational table in the sense that it is a collection of objects of the same type (rows). Data in a table can be related according to common keys or concepts, and the ability to retrieve related data from a table is the basis for the term relational database. A database management system (DBMS) of the computing environment 100 controls the way data in the encoded data/information repository 850 is stored, maintained, and retrieved. A database management system of the computing environment 100 performs the tasks of determining the way data and other information are stored, maintained, and retrieved from the encoded data/information repository 850.

FIG. 8B depicts additional details of how the encoded domain-specific data/information 840 can be implemented in accordance with aspects of the invention. As shown in FIG. 8B, the encoded domain-specific data/information 840 can include domain-specific variables 842 of the CDPL, domain-specific variable features 844 of the CDPL, and domain-specific rules/syntax 846 of the CDPL. The domain-specific variables 842 are generated using the CDL structures module 812 of the CDPL module 810. The domain-specific variable features 844 can also be generated using the CDPL structures module 812 of the CDPL module 810. The domain-specific rules/syntax 846 can be generated using the CDP rules/syntax module 814 of the CDPL module 810.

The components/modules of the programming language encoding system 800 (shown in FIG. 8A) are depicted separately for ease of illustration and explanation. In embodiments of the invention, the functions performed by the components/modules of the programming language encoding system 800 can be distributed differently than shown without departing from the scope of the various embodiments of the invention describe herein. For example, in some embodiments of the invention, the encoding algorithm 820 can be incorporated within the CDPL module 810.

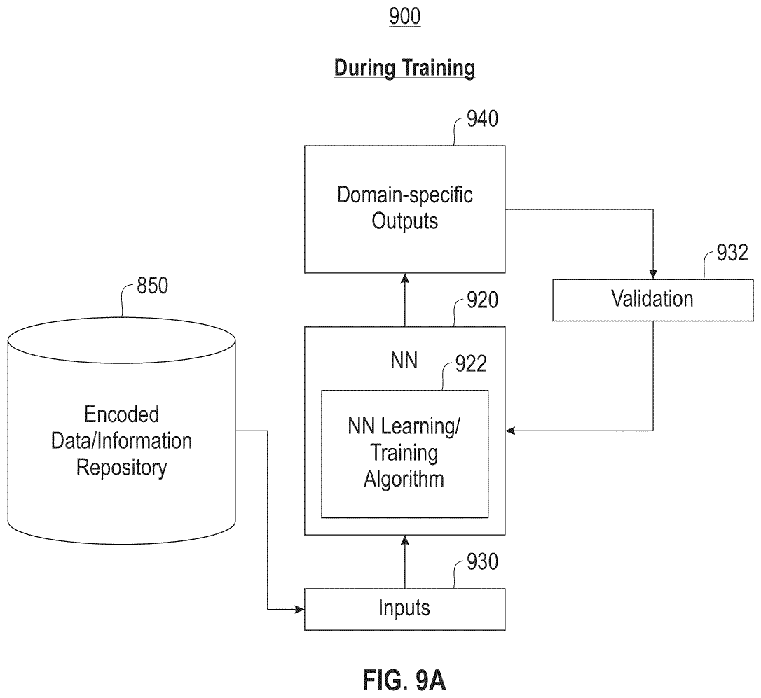

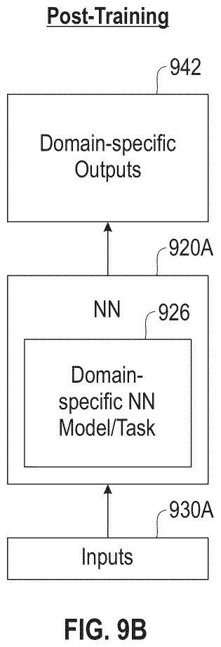

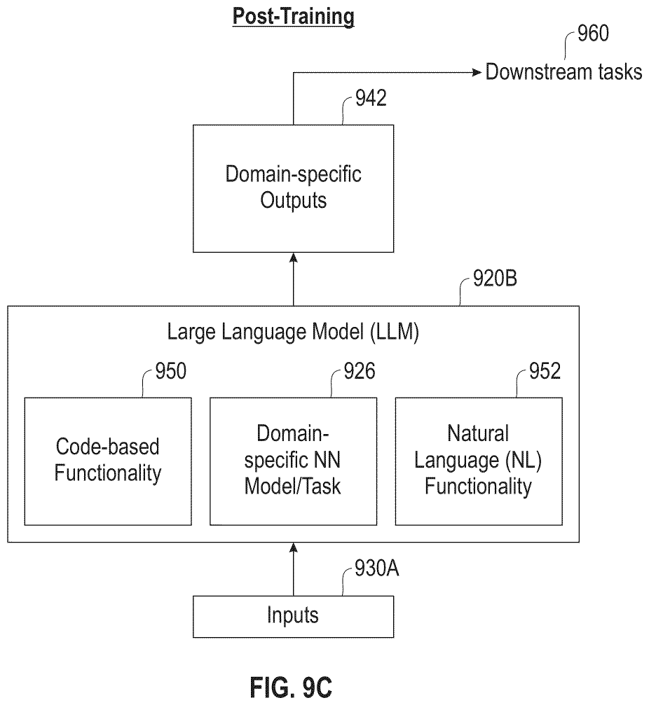

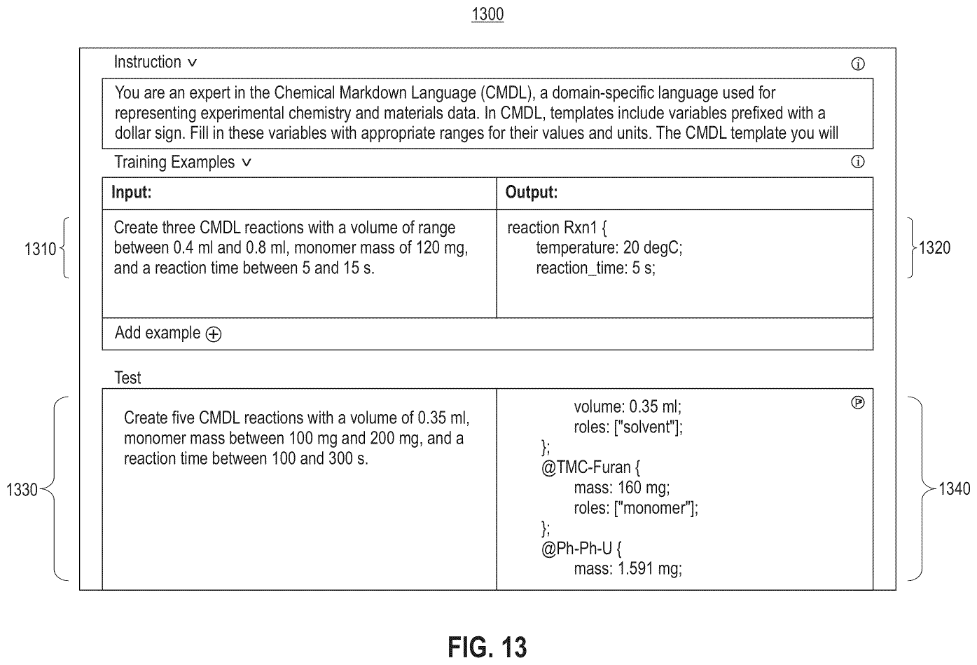

FIG. 9A depicts a simplified block diagram of a system 900 operable to train/generate a NN 920 in accordance with aspects of the invention. Training/generation performed by a NN learning/training algorithm 922 of the NN 920 involves selecting the best weight and bias values to achieve the accuracy of the resulting domain-specific NN model/task 926 (shown in FIG. 9B) on a validation set 932. The validation set 932 is used to monitor the performance of the NN 920 during training. In embodiments of the invention where the inputs 930 retrieved from the encoded data/information repository 850 are instances of the encoded domain-specific data/information 840, and where the encoding is provided by the CDPL of the CDPL structures module 810, the validation set 932 can be provided using a compiler of the CDPL of the CDPL structures module 810. In the evaluation step, the performance of the new model/task (e.g., domain-specific NN model/task 926 shown in FIG. 9B) is evaluated on a test set (e.g., the input representations 1130, 1330 shown in FIGS. 11 and 13; and the output representations 1140, 1340 shown in FIGS. 11 and 13). The test set is used to measure the generalization performance of the new model/task. If the new model/task performs well on the test set, it can be deployed in a production environment.

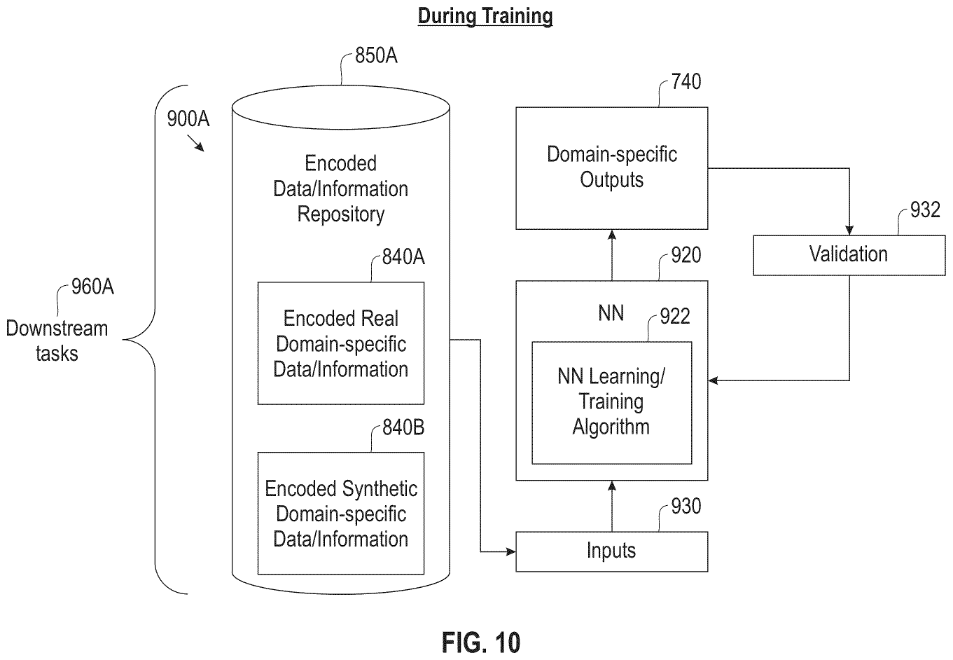

As shown in FIG. 9A, in accordance with embodiments of the invention, the inputs 930 are various forms of labeled or unlabeled instances of the encoded domain-specific data/information 840 and the encoded real domain-specific data/information 840A (shown in FIGS. 8A, 8B, 10) retrieved from the encoded data/information repository 850; the NN learning/training algorithm 922 is any suitable learning methodology for training the NN 920; and the outputs 940 are domain-specific outputs 940 generated by NN 920 during training and/or tuning. As shown, the training operation performed by the system 900 includes supplying the inputs 930 to the NN 920, and applying the NN training functionality 922 to the inputs 930 to generate the domain-specific outputs 940.

FIG. 9B depicts a NN 920A, post-training, which is the NN 920 (shown in FIG. 9A) after the training/generation has been completed. The NN 920A is obtained via performance of the training shown in FIG. 9A and includes a domain-specific NN model/task 926 in accordance with embodiments of the invention. In response to inputs 930A, the domain-specific NN model/task 926 generates domain-specific outputs 942 in accordance with aspects of the invention.

FIG. 9C depicts a NN 920B, post-training, which is the NN 920 (shown in FIG. 9A) after the training/generation has been completed. The NN 920B is implemented as a LLM having code-based functionality 950, the domain-specific NN model/task 926, and NL functionality 952. The NN 920A is obtained via performance of the training shown in FIG. 9A and includes a domain-specific NN model/task 926 in accordance with embodiments of the invention. In response to inputs 930A, the domain-specific NN model/task 926 generates domain-specific outputs 942 in accordance with aspects of the invention. In some embodiments of the invention, the domain-specific outputs 942 can be synthetic data/information that is provided to downstream tasks 960 that perform additional operations, including but not limited to using the synthetic data/information to augment the training data available in the encoded data/information repository 850, 850A.

FIG. 10 depicts a non-limiting example of a downstream task 960A in which the encoded data/information repository 850 has been augmented with encoded synthetic domain-specific data/information 840B to create the encoded data/information repository 850A. The system 900A shown in FIG. 10 is substantially the same as the system 900 shown in FIG. 9A except the system 900A makes available and/or provides both encoded real domain-specific data/information 840A and encoded synthetic domain-specific data/information 840B. The increased volume of training data in the encoded data/information repository 850A provides a sufficient volume of training data to train the NN 920 as an LLM. In some embodiments of the invention, the NN 920 can be implemented as a foundation model. In general, foundation models are AI models designed to produce a wide and general variety of outputs. They are capable of a range of possible tasks and applications, such as text, image or audio generation. They can be standalone systems or can be used as a “base” for many other applications.

FIGS. 11, 12, and 13 depict example screenshots 1100, 1200, 1300 showing inputs and outputs generated during-training, during-testing, and post-training using the systems 800, 900, 900A shown in FIGS. 8A, 9A, 10 in accordance with embodiments of the invention. Using FIG. 11 as an example, various input representations 1110A, 1110B, 1110C, 1130 are shown on the left side of the screenshot 1100; and various output representations 1120A, 1120B, 1120C, 1140 are shown on the right side of the screenshot 1100. The input representations 1110A, 1110B, 1110C, 1130 can be provided as pre-encoded domain information. In the embodiments of the invention depicted in FIG. 11, the pre-encoded domain information is implemented as or pre-encoded as NL domain information (and/or CDPL information) presented in the form of a questions or query. The output representations 1120A, 1120B, 1120C, 1140 can be provided as one or both of the encoded real domain-specific data/information 840A and/or the encoded synthetic domain-specific data/information 840B. In some embodiments of the invention, the one or both of the encoded real domain-specific data/information 840A and/or the encoded synthetic domain-specific data/information 840B can each be a response to a corresponding inquiry represented by the various input representations 1110A, 1110B, 1110C, 1130. In embodiments of the invention, the encoded real domain-specific data/information 840A and/or encoded synthetic domain-specific data/information 840B can be encoded in CDPL.

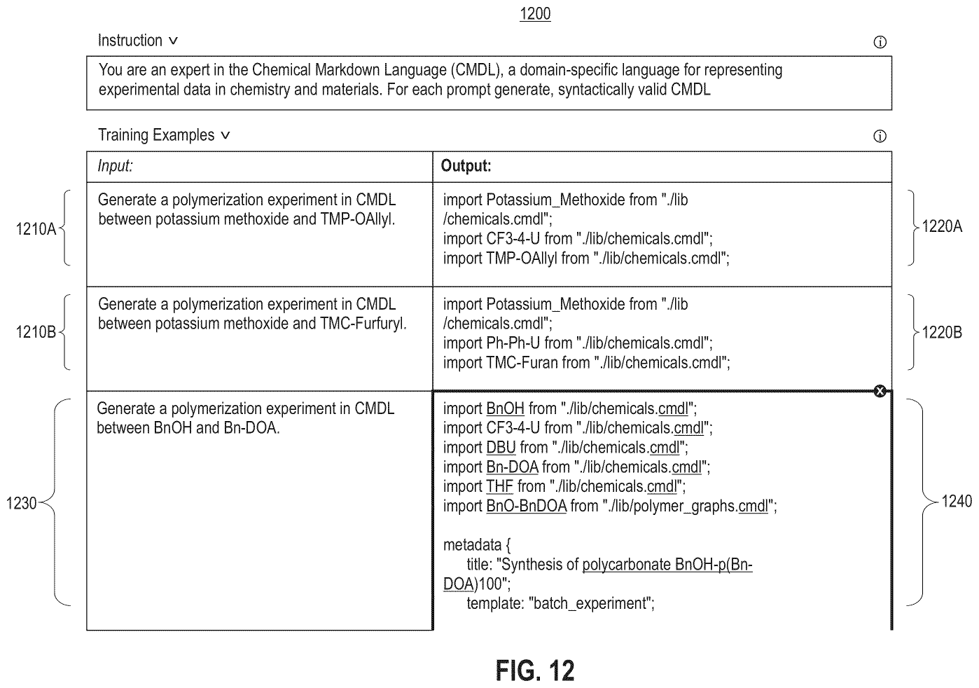

Similarly, in FIG. 12, various input representations 1210A, 1210B, 1230 are shown on the left side of the screenshot 1200; and various output representations 1220A, 1220B, 1240 are shown on the right side of the screenshot 1200. The input representations 1210A, 1210B, 1230 can be provided as pre-encoded domain information. In the embodiments of the invention depicted in FIG. 12, the pre-encoded domain information is implemented as or pre-encoded as NL domain information (and/or CDPL information) presented in the form of a questions or query. The output representations 1220A, 1220B, 1240 can be provided as one or both of the encoded real domain-specific data/information 840A and/or the encoded synthetic domain-specific data/information 840B. In some embodiments of the invention, one or both of the encoded real domain-specific data/information 840A and/or the encoded synthetic domain-specific data/information 840B can each be a response to a corresponding inquiry represented by the various input representations 1210A, 1210B, 1230. In embodiments of the invention, the encoded real domain-specific data/information 840A and/or encoded synthetic domain-specific data/information 840B can be encoded in CDPL.

Similarly, in FIG. 13, various input representations 1310, 1330 are shown on the left side of the screenshot 1300; and various output representations 1320, 1340 are shown on the right side of the screenshot 1300. More specifically, input 1310 and output 1320 are training examples; and input 1330 and output 1340 are test examples. The input representations 1310, 1330 can be provided as pre-encoded domain information. In the embodiments of the invention depicted in FIG. 13, the pre-encoded domain information is implemented as, or pre-encoded as, NL domain information (and/or CDPL information) presented in the form of a questions or query. The output representations 1320, 1340 can be provided as one or both of the encoded real domain-specific data/information 840A and/or the encoded synthetic domain-specific data/information 840B. In some embodiments of the invention, one or both of the encoded real domain-specific data/information 840A and/or the encoded synthetic domain-specific data/information 840B can each be a response to a corresponding inquiry represented by the various input representations 1310, 1330. In embodiments of the invention, the encoded real domain-specific data/information 840A and/or encoded synthetic domain-specific data/information 840B can be encoded in CDPL.

The NNs 920, 920A, 920B can be implemented as generative networks. In general, generative networks utilize generative modeling, which is a type of unsupervised learning problem that automatically discovers and learns the regularities or patterns in input data in such a way that the model can be used to generate or output new examples that plausibly could have been drawn from the original dataset. Examples of suitable generative algorithms that can be used to implement aspects of the invention include generative adversarial networks (GANs) and auto-encoders (AEs) (e.g., a variational AE (VAE)).

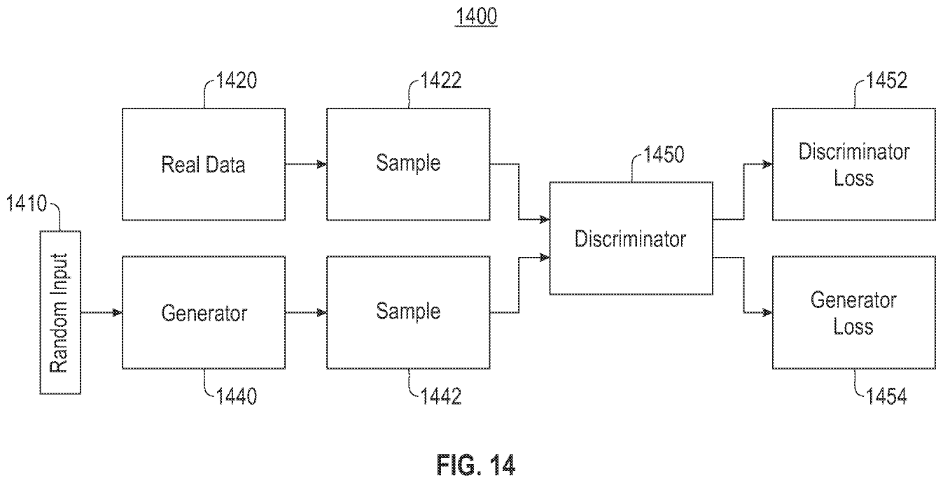

FIG. 14 depicts a non-limiting example of how any one or more of the NNs 920, 920A, 920B (shown in FIGS. 9A, 9B, 9C, 10) can be implemented as generative adversarial network (GAN) 1400. The GAN 1400 can model the distribution of data by imitating that distribution. For example, the generator can model a distribution by producing convincing “fake” data that looks like it's drawn from that distribution. The GAN 1400 pairs a generator 1440, which learns to produce the target output, with a discriminator 1450, which learns to distinguish true data from the output of the generator 1440. The generator 1440 tries to fool the discriminator 1450, and the discriminator 1450 tries to keep from being fooled. More specifically, the generator 1440 learns to generate plausible data (e.g., samples 1442), and the generated plausible data (e.g., samples 1442) from the generator 1440 become negative training examples for the discriminator 1450. The discriminator 1450 learns to distinguish the generated plausible data (e.g., samples 1442) from the generator 1440 from real data 1420 from which samples 1422 are drawn. The discriminator 1450 penalizes the generator 1440 for producing implausible results. When training of the GAN 1400 begins, the generator 1440 produces obviously fake data, and the discriminator 1450 quickly learns to tell that it is fake. As training continues, the generator 1440 moves closer to producing output that can fool the discriminator 1450. If training proceeds well, the discriminator 1450 becomes less able to tell the difference between fake data and real data and will begins classifying fake data as real data. The generator 1440 and the discriminator 1450 can be implemented as neural networks. The samples 1442 output from the generator 1440 are fed directly to the discriminator 1450.

The discriminator 1450 performs classification operations to output classifications (not shown separately from the discriminator 1450) of the samples 1422, 1442 as real or fake, along with a discriminator loss 1452 and a generator loss 1454. Through backpropagation, the discriminator 1450 uses the discriminator classification outputs and the discriminator loss 1452 to train the discriminator 1450 without training the generator 1440. During training of the discriminator 1450, the discriminator 1450 ignores the generator loss 1454 and just uses the discriminator loss 1452. The discriminator loss 1452 penalizes the discriminator 1450 for misclassifying an instance of the sample 1422 as fake or for misclassifying an instance of the sample 1442 as real. The discriminator 1450 updates its weights through backpropagation from the discriminator loss 1452.

During training of the generator 1440, the generator 1440 learns to create fake data by incorporating feedback from the discriminator 1450. More specifically, the generator 1440 learns to make the discriminator 1450 classify the samples 1442 as real. Training the generator 1440 also uses backpropagation but requires tighter integration between the generator 1440 and the discriminator 1450 than is required for the training of the discriminator 1450. The portion of the GAN 1400 that trains the generator 1440 includes the random input 1410, the generator 1440, the discriminator 1450, the classifications generated by the discriminator 1450, and the generator loss 1454. The random input 1410 can begin as random noise that the generator 1440 will, over time, transform into meaningful outputs. The backpropagation used during training of the generator 1440 flows from the generator loss 1454 back through the discriminator 1450 into the generator 1440 to obtain gradients, which are used to change only the weights of the generator 1440. The training process for the overall GAN 1400 alternates between training the discriminator 1450 for one or more epochs; and then training the generator 1440 for one or more epochs until the GAN 1400 converges.

FIG. 15 depicts a non-limiting example of how any one or more of the NNs 920, 920A, 920B (shown in FIGS. 9A, 9B, 9C, 10) can be implemented as a GNN 1500. In accordance with embodiments of the invention, the GNN 1500 includes an encoder stage 1560, a latent code stage 1530, and a decoder stage 1570, configured and arranged as shown. The encoder stage 1560 receives the inputs 1502 and performs multiple successive compressions or encodings to generate compressed code 1522 in hidden layers 1520. Although only one instance of compressed code 1522 is shown, any number of successive compressions or encodings can be employed until a desired lower dimension space for the latent code stage 1530 is reached.

The latent code stage 1530 is provided to the decoder stage 1570 where it is decompressed through successive decompressions to generate decompressed code 1542 in hidden layer 1540. Although only one instance of decompressed code 1542 is shown, any number of successive decompressions or decodings can be employed until a reconstructed version of the inputs 1502 is produced at the outputs 1504. The inputs 1502 minus the outputs 1504 represent a reconstruction loss 1580. In a VAE implementation of the GNN 1500, the training is “regularized” to avoid overfitting and ensure that the latent code stage 1530 has good properties that enable generative process. A VAE addresses the issue of non-regularized latent code and provides the generative capability to the entire latent code stage 1530. Similar to an AE, the encoder in a VAE outputs latent vectors, but instead of outputting the vectors in the latent code stage 1530, the encoder of a VAE outputs parameters of a pre-defined distribution in the latent code stage 1530 for every one of the inputs 1502. The VAE then imposes a constraint on this latent distribution forcing it to be a normal or smooth distribution. This constraint makes sure that the latent code stage 1530 is regularized or smoothed.

The inputs 1502, compressed code 1522, latent code stage 1530, decompressed code 1542, and outputs 1504 are each represented as a first series of nodes (N) 1514, a second series of nodes (N) 1524, a third series of nodes (N) 1534, a fourth series of nodes (N) 1544, and a fifth series of nodes (N) 1552, respectively. In accordance with embodiments of the invention, the inputs 1502 and the outputs 1504 can each be presented as any combination of one or more of the input representations 1110A, 1110B, 1110C, 1210A, 1210B, 1310 (shown in FIGS. 11, 12, 13) and the output representations 1120A, 1120B, 1120C, 1220A, 1220B, 1320 (shown in FIGS. 11, 12, 13).

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method comprising:
executing a machine learning (ML) model operable to perform a ML task comprising generating a ML output responsive to a ML input;
wherein the ML output comprises encoded domain information associated with a domain;
wherein the encoded domain information is encoded in a computer-code-based domain-specific data structure; and
wherein the ML task is associated with the domain.

2. The computer-implemented method of claim 1, wherein the ML input comprises pre-encoded domain information.

3. The computer-implemented method of claim 2, wherein:
the pre-encoded domain information comprises a natural language question comprising a natural language data structure; and
the ML output is responsive to the natural language question of the ML input.

4. The computer-implemented method of claim 1, wherein the ML model comprises a large language model (LLM) operable to understand a domain-specific syntax of the computer-code-based domain-specific data structure.

5. The computer-implemented method of claim 1, wherein the ML model comprises a generative model.

6. The computer-implemented method of claim 5, wherein the encoded domain information comprises encoded synthetic data.

7. The computer-implemented method of claim 5, wherein the encoded domain information represents one or more new material designs.

8. A computer system comprising a processor system and a memory electronically coupled to the processor system, wherein the processor system is operable to perform processor system operations comprising:
executing a machine learning (ML) model operable to perform a ML task comprising generating a ML output responsive to a ML input;
wherein the ML output comprises encoded domain information associated with a domain;
wherein the encoded domain information is encoded in a computer-code-based domain-specific data structure; and
wherein the ML task is associated with the domain.

9. The computer system of claim 8, wherein:
the ML model is trained to perform the ML task using domain-specific training information encoded in the computer-code-based domain-specific data structure;
the ML input comprises a natural language question comprising a natural language data structure;
the ML model comprises a large language model (LLM) operable to understand a domain-specific syntax of the computer-code-based domain-specific data structure; and
the LLM comprises a generative LLM.

10. A computer program product comprising a computer readable program stored on a computer readable storage medium, wherein the computer readable program, when executed on a processor system, causes the processor system to perform processor system operations comprising:
executing a machine learning (ML) model operable to perform a ML task comprising generating a ML output responsive to a ML input;
wherein the ML output comprises encoded domain information associated with a domain;
wherein the encoded domain information is encoded in a computer-code-based domain-specific data structure; and
wherein the ML task is associated with the domain.

11. The computer program product of claim 10, wherein:
the ML model is trained to perform the ML task using domain-specific training information encoded in the computer-code-based domain-specific data structure;
the ML input comprises a natural language question comprising a natural language data structure;
the ML model comprises a large language model (LLM) operable to understand a domain-specific syntax of the computer-code-based domain-specific data structure; and
the LLM comprises a generative LLM.

12. A computer-implemented method comprising:
executing a machine learning (ML) model operable to perform a ML task comprising generating a ML output responsive to a ML input;
wherein the ML output comprises encoded domain information associated with a domain;
wherein the encoded domain information is encoded in a domain-specific programming language data structure;
wherein the ML model is operable to understand a domain-specific syntax of the domain-specific programming language data structure; and
wherein the ML task is associated with the domain.

13. The computer-implemented method of claim 12, wherein the ML model is trained to perform the ML task using domain-specific training information encoded in the domain-specific programming language data structure.

14. The computer-implemented method of claim 13, wherein the ML input comprises a natural language question having a natural language data structure.

15. The computer-implemented method of claim 12, wherein:
the domain comprises chemical structures and chemical interactions of materials; and
the domain-specific programming language data structure comprises a chemical markdown language (CMDL) data structure.

16. The computer-implemented method of claim 15, wherein the ML model comprises a large language model (LLM) operable to understand a domain-specific syntax of the domain-specific programming language data structure.

17. The computer-implemented method of claim 15, wherein:
the ML model comprises a generative model; and
the encoded domain information comprises encoded synthetic data.

18. A computer-implemented method comprising:
accessing encoded domain information encoded in a domain-specific programming language data structure;
wherein the encoded domain information results from an encoding operation that generates, based at least in part on domain information having multiple data structures, the encoded domain information encoded in the domain-specific programming language data structure; and
using the encoded domain information to generate a machine learning (ML) model operable to perform a ML task comprising generating a ML output responsive to a ML input;
wherein the ML model is operable to understand a domain-specific syntax of the domain-specific programming language data structure; and
wherein the ML task is associated with the domain.

19. The computer-implemented method of claim 18, wherein the multiple data structures are selected from a group consisting of tables, charts, images, and video.

20. The computer-implemented method of claim 18, wherein:
the domain comprises chemical structures and chemical interactions of materials; and
the domain-specific programming language data structure comprises a chemical markdown language (CMDL) data structure.

21. The computer-implemented method of claim 18, wherein the ML model comprises a large language model (LLM).

22. The computer-implemented method of claim 21, wherein the ML input comprises multiple input modalities including natural language text.

23. The computer-implemented method of claim 21, wherein:
the LLM comprises a generative model; and
the ML output comprises synthetic data.

24. The computer-implemented method of claim 23 further comprising using a validation module to validate the synthetic data.

25. The computer-implemented method of claim 24, wherein the validation module comprises a CMDL compiler.
